(19) United States
(12) Patent Application Publication
(10) Pub. No.: US 2018/0234585 A1
(43) Pub. Date: Aug. 16, 2018

(54) AUTHENTICATION METHOD AND RECORDING MEDIUM

(71) Applicant: Shunsuke YANO, Kanagawa (JP)

(72) Inventor: Shunsuke YANO, Kanagawa (JP)

(73) Assignee: Ricoh Company, Ltd., Tokyo (JP)

(21) Appl. No.: 15/882,089

(22) Filed: Jan. 29, 2018

(30) Foreign Application Priority Data
Feb. 16, 2017 (JP) 2017-027267

(51) Int. Cl. H04N 1/44; G06F 21/34; G06K 19/07

(52) U.S. Cl. CPC H04N 1/4413; G06K 19/07; G06F 21/34; H04N 1/4433

(57) ABSTRACT

An authentication method includes requesting for user authentication based on first authentication information input via a reading device according to a user's operation; displaying a first screen for inputting second authentication information including user identification information, in response to the user authentication being unsuccessful based on the first authentication information; requesting for user authentication based on the second authentication information input via the first screen; allowing the user to log in, in response to the user authentication being successful based on the second authentication information; displaying a second screen for inputting an instruction as to whether to register the first authentication information, in response to the user being allowed to log in; and controlling the first authentication information and the user identification information included in the second authentication information to be registered in association with each other, in response to the first authentication information being instructed to be registered.

### CROSS-REFERENCE TO RELATED APPLICATION

The present application claims priority under 35 U.S.C. § 119 to Japanese Patent Application No. 2017-027267, filed on Feb. 16, 2017, the contents of which are incorporated herein by reference in their entirety.

### BACKGROUND OF THE INVENTION

### 1. Field of the Invention

The present invention relates to an authentication method and a recording medium.

### 2. Description of the Related Art

In the related art, in an image processing apparatus such as a MultiFunction Peripheral (MFP), a technique is used in which user authentication is performed to allow a user to use the image processing apparatus. For example, the user authentication is performed by user information including user identification information and a password input by a user, or by integrated circuit (IC) card authentication based on IC card information read from an IC card (for example, an employee identification card, etc.) possessed by a user. In order to perform IC card authentication, the IC card information needs to be registered in a server, etc., in advance. It is known that this kind of a registration operation is typically performed by manual operations by an administrator, etc., which is a troublesome task.

### SUMMARY OF THE INVENTION

An aspect of the present invention provides an authentication method and a recording medium in which one or more of the disadvantages of the related art are reduced.

According to one aspect of the present invention, there is provided an authentication method executed by a computer, the authentication method including requesting for user authentication based on first authentication information input via a reading device according to an operation by a user; displaying, on a display device, a first screen used for inputting second authentication information including user identification information for identifying the user, in response to the user authentication being unsuccessful based on the first authentication information; requesting for user authentication based on the second authentication information input via the first screen; allowing the user to log in, in response to the user authentication being successful based on the second authentication information; displaying, on the display device, a second screen used for the user to input an instruction as to whether to register the first authentication information, in response to user being allowed to log in; and controlling the first authentication information and the user identification information included in the second authentication information to be registered in association with each other, in response to the first authentication information being instructed to be registered via the second screen.

### BRIEF DESCRIPTION OF THE DRAWINGS

FIG. 1 is a diagram illustrating a configuration of a management system according to a first embodiment of the present invention;

FIG. 2 is a hardware block diagram of an image processing apparatus according to the first embodiment of the present invention;

FIG. 3 is a functional block diagram of the management system according to the first embodiment of the present invention;

FIG. 4 is a sequence diagram illustrating a procedure of processes by the management system according to the first embodiment of the present invention;

FIGS. 5A and 5B are diagrams illustrating examples of a user information table and an IC card information table according to the first embodiment of the present invention;

FIG. 6 is a diagram illustrating a transition example of the display screen in the image processing apparatus according to the first embodiment of the present invention;

FIG. 7 is a diagram illustrating the configuration of a management system according to a second embodiment of the present invention;

FIG. 8 is a functional block diagram of the management system according to the second embodiment of the present invention;

FIG. 9 is a sequence diagram illustrating a procedure of processes by the management system according to the second embodiment of the present invention;

FIG. 10 is a sequence diagram illustrating a procedure of processes by the management system according to the second embodiment of the present invention;

FIG. 11 is a diagram illustrating an example of unregistered IC card information according to the second embodiment of the present invention;

FIGS. 12A and 12B are diagrams illustrating display examples of a display screen in the image processing apparatus according to the second embodiment of the present invention;

FIG. 13 is a diagram illustrating a configuration of a management system according to a third embodiment of the present invention;

FIG. 14 is a functional block diagram of the management system according to the third embodiment of the present invention; and

FIG. 15 is a functional block diagram of an image processing apparatus according to a fourth embodiment of the present invention.

### DETAILED DESCRIPTION OF THE PREFERRED EMBODIMENTS

In view of troublesome tasks that have been required for registering IC card information in a server in advance, the related art discloses the following technique. Specifically, when an IC card possessed by a user is held over an IC card reader of a multifunction peripheral, but the IC card is not registered in an authentication server, user authentication is performed by a user name and a password input by the user. When the result of the user authentication is OK, the card ID of the IC card and the user name input by the user are registered in association with each other in the authentication server. According to this technique, it is assumed that troublesome tasks by the administrator can be reduced.

However, in the related art, after registering an IC card in the authentication server, when the user uses the image processing apparatus, it is necessary to perform user authentication or IC card authentication again. Therefore, the user needs to hold the IC card over the IC card reader again, or input user information again. Thus, in the related art, when a user registers an IC card, it has not been easy for the user to use the image processing apparatus.

A problem to be solved by an embodiment of the present invention is to make it possible for the user to easily use an image processing apparatus when the user registers authentication information that is input via a reading device.

### First Embodiment

A first embodiment of the present invention will be described by referring to the accompanying drawings.

### Configuration of Management System 10—First Embodiment

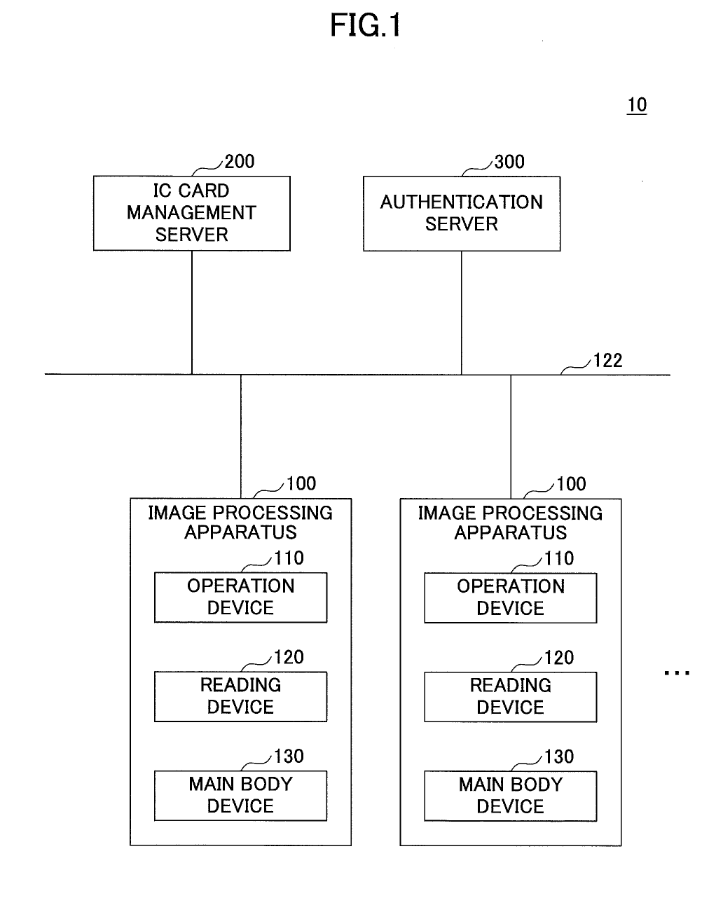

FIG. 1 is a diagram illustrating a configuration of a management system 10 according to the first embodiment of the present invention. The management system 10 illustrated in FIG. 1 includes a plurality of image processing apparatuses 100, an IC card management server 200, and an authentication server 300. The plurality of image processing apparatuses 100, the IC card management server 200, and the authentication server 300 are connected to a network 122 (for example, an in-house Local Area Network (LAN) and a Virtual Private Network (VPN), etc.).

The image processing apparatus 100 is a so-called multifunction peripheral, and includes a plurality of image processing functions such as a copy function, a scan function, a fax function, and a printer function, etc. When the user uses the image processing apparatus 100, the image processing apparatus 100 performs IC card authentication based on IC card information (an example of “first authentication information” of the present invention), or user authentication based on user information including user identification information for identifying the user (an example of the “second authentication information” of the present invention), to allow the user to use the image processing apparatus 100. In particular, in the present embodiment, the image processing apparatus 100 causes the IC card management server 200 to perform IC card authentication. Furthermore, the image processing apparatus 100 causes the authentication server 300 to perform user authentication.

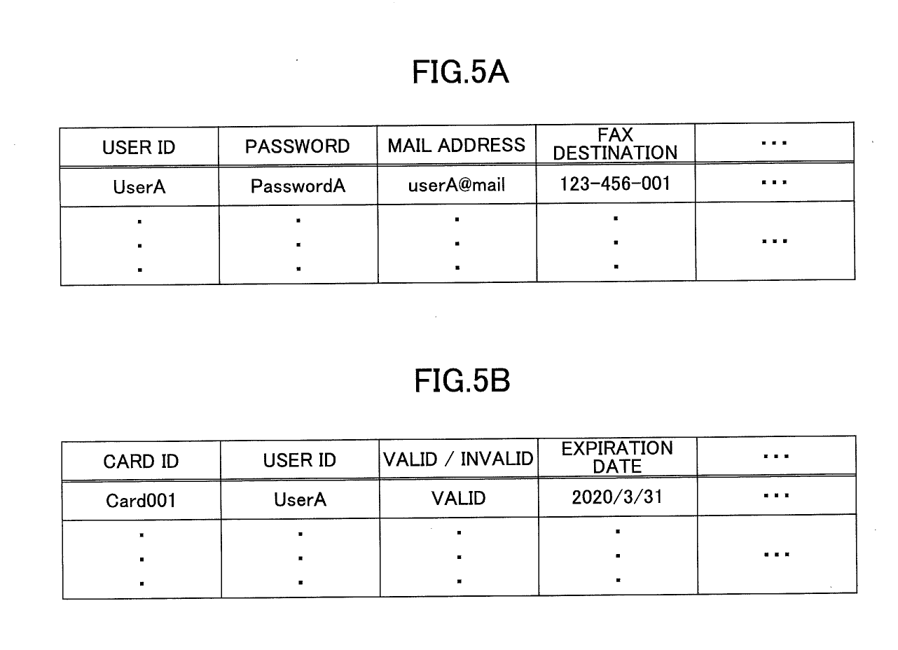

The IC card management server 200 manages a plurality of pieces of IC card information with an IC card information table (see FIGS. 5A and 5B). Furthermore, the IC card management server 200 performs IC card authentication in response to a request from the image processing apparatus 100.

The authentication server 300 manages a plurality of pieces of user information with a user information table (see FIGS. 5A and 5B). Furthermore, the authentication server 300 performs user authentication in response to a request from the image processing apparatus 100.

In the management system 10 configured as described above, when the IC card possessed by the user is an IC card for which the IC card information is not registered in the IC card management server 200 (hereinafter referred to as “unregistered IC card”), the user himself/herself can register the IC card information of the IC card in the IC card management server 200 from the image processing apparatus 100. In particular, the present embodiment has a configuration in which the user can easily use the image processing apparatus 100 when the user registers IC card information. Hereinafter, this point will be specifically described.

### Hardware Configuration of Image Processing Apparatus 100—First Embodiment

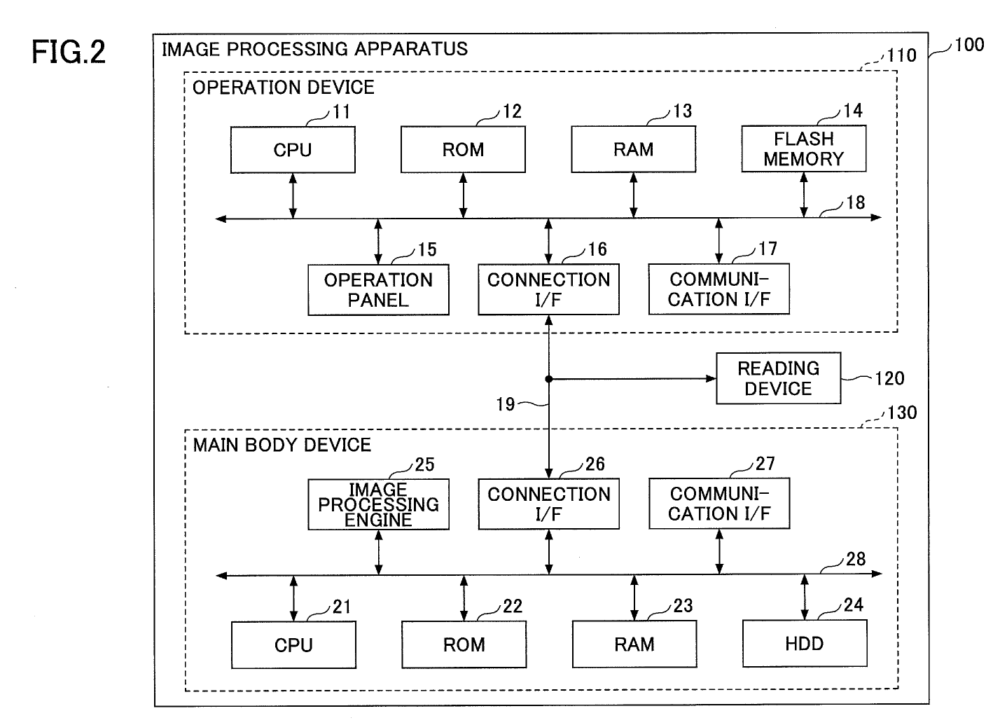

FIG. 2 is a hardware block diagram of the image processing apparatus 100 according to the first embodiment of the present invention. As illustrated in FIG. 2, the image processing apparatus 100 includes an operation device 110, a reading device 120, and a main body device 130.

The operation device 110 is used to input various kinds of input information (for example, a user ID and a password, etc.), and execution requests for various image processing functions, to the image processing apparatus 100. The reading device 120 is a so-called IC card reader, and is a device that reads IC card information (for example, a card ID, etc.) from the IC card by performing wireless communication with the IC card possessed by the user. The main body device 130 executes various image processing functions (for example, a copy function, a scan function, a fax function, and a printer function, etc.) in response to an execution request input by the user from the operation device 110.

The operation device 110 includes a Central Processing Unit (CPU) 11, a Read-Only Memory (ROM) 12, a Random Access Memory (RAM) 13, a flash memory 14, an operation panel 15, a connection interface (I/F) 16, and a communication I/F 17. These hardware elements are mutually connected via a bus 18.

The CPU 11 executes various programs stored in the ROM 12 or the flash memory 14. The ROM 12 is a nonvolatile memory. For example, the ROM 12 stores various programs executed by the CPU 11 and data necessary for the CPU 11 to execute various programs, etc. The RAM 13 is a main memory such as a Dynamic Random Access Memory (DRAM) or a Static Random Access Memory (SRAM). For example, the RAM 13 functions as a work area used when the CPU 11 executes various programs.

The flash memory 14 is a nonvolatile storage device. For example, the flash memory 14 stores various programs executed by the CPU 11 and data necessary for the CPU 11 to execute various programs, etc. The operation panel 15 has a function of an input device for inputting various kinds of input information and a function of a display device for displaying various kinds of display information. As the operation panel 15, for example, a touch panel, etc., is used.

The connection I/F 16 is an interface for communicating with the main body device 130 and the reading device 120 via a communication path 19. The communication I/F 17 is an interface for communicating with an external device (for example, the IC card management server 200 and the authentication server 300, etc.) via a network (for example, the network 122).

The main body device 130 includes a CPU 21, a ROM 22, a RAM 23, a HDD 24, an image processing engine 25, a connection I/F 26, and a communication I/F 27. These hardware elements are mutually connected via a bus 28.

The CPU 21 executes various programs stored in the ROM 22 or the HDD 24. The ROM 22 is a nonvolatile memory. For example, the ROM 22 stores. various programs executed by the CPU 21 and data necessary for the CPU 21 to execute various programs, etc. The RAM 23 is a main storage device such as a DRAM and a SRAM, etc. For example, the RAM 23 functions as a work area used when the CPU 21 executes various programs. The HDD 24 is a nonvolatile storage device. For example, the HDD 24 stores various programs to be executed by the CPU 21 and data necessary for the CPU 21 to execute various programs, etc.

The image processing engine 25 performs image processing for implementing a plurality of image processing functions such as a copy function, a scan function, a fax function, and a printer function, etc. The image processing engine 25 includes, for example, a scanner that optically reads a document to generate image data, a plotter that performs printing on a sheet material such as paper, and a fax communication device that performs fax communication. Furthermore, the image processing engine 25 may include, for example, a finisher for sorting printed sheet materials and an automatic document feeder (ADF) for automatically feeding the document, etc.

The connection I/F 26 is an interface for communicating with the operation device 110 and the reading device 120 via the communication path 19. The communication I/F 27 is an interface for communicating with another device (for example, the IC card management server 200 and the authentication server 300, etc.) via a network (for example, the network 122).

In FIG. 2, the configuration in which the image processing apparatus 100 includes the operation device 110 has been illustrated as an example; however, the present invention is not limited as such. The operation device 110 may be, for example, an information processing terminal such as a tablet terminal, a smartphone, a mobile phone, and Personal Digital Assistant (PDA), etc.

Since the hardware configuration of the IC card management server 200 and the authentication server 300 is basically the same as the hardware configuration of the main body device 130 of the image processing apparatus 100 described above, illustrations and descriptions thereof will be omitted (however, the image processing engine 25 and the connection I/F 26 may not be provided).

### Functional Configuration of Management System 10—First Embodiment

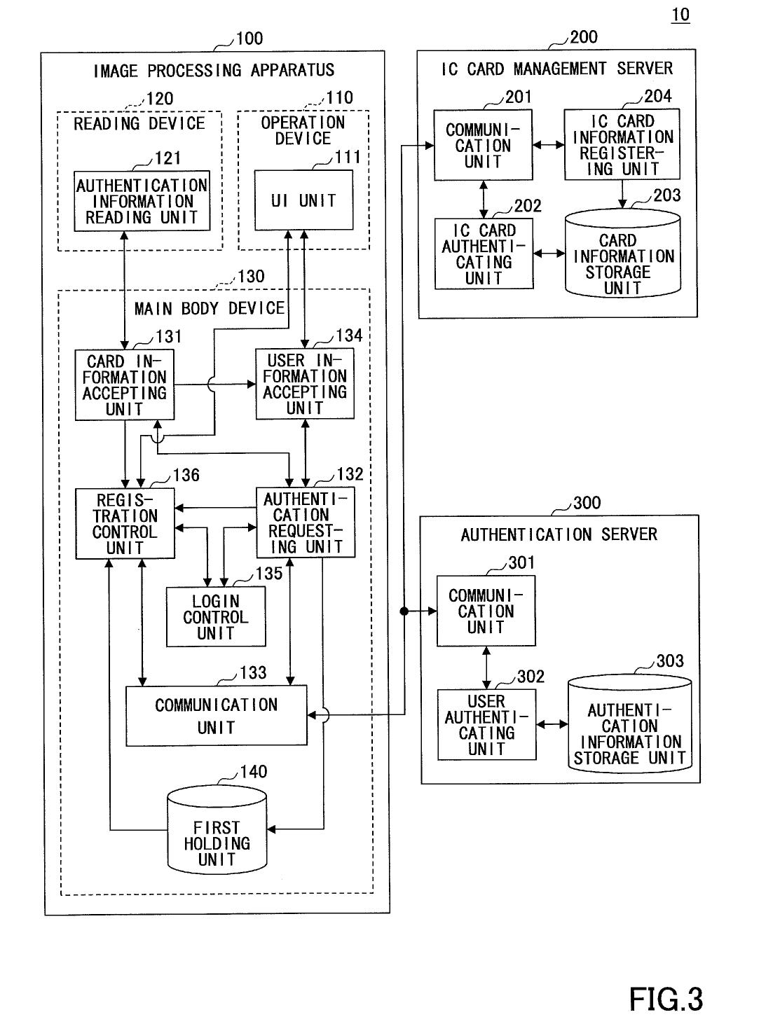

FIG. 3 is a functional block diagram of the management system 10 according to the first embodiment of the present invention.

### Functional Configuration of Image Processing Apparatus 100—First Embodiment

As illustrated in FIG. 3, the image processing apparatus 100 includes a User Interface (UI) unit 111, an authentication information reading unit 121, a card information accepting unit 131, an authentication requesting unit 132, a communication unit 133, a user information accepting unit 134, a login control unit 135, a registration control unit 136, and a first holding unit 140.

The UI unit 111 is a function of the operation device 110 and accepts input of various kinds of input information (for example, user information including a user ID and a password) from the user. Furthermore, the UI unit 111 displays various kinds of display information for the user. That is, the UI unit 111 functions as a “display device” according to an embodiment of the present invention.

The authentication information reading unit 121 is a function of the reading device 120, and reads the IC card information from the IC card possessed by the user.

The card information accepting unit 131 accepts input of IC card information by receiving, from the authentication information reading unit 121, IC card information (card ID) read by the authentication information reading unit 121.

The authentication requesting unit 132 requests the IC card authentication based on the IC card information accepted by the card information accepting unit 131. That is, the authentication requesting unit 132 has a function of a “first authentication requesting unit” according to an embodiment of the present invention. Specifically, the authentication requesting unit 132 transmits an authentication request including the IC card information to the IC card management server 200 via the communication unit 133, to cause the IC card management server 200 to perform IC card authentication. Then, the authentication requesting unit 132 receives the authentication result of the IC card authentication from the IC card management server 200.

Furthermore, the authentication requesting unit 132 requests user authentication based on the user information accepted by the user information accepting unit 134. That is, the authentication requesting unit 132 has a function of a “second authentication requesting unit” according to an embodiment of the present invention. Specifically, the authentication requesting unit 132 transmits an authentication request including user information to the authentication server 300 via the communication unit 133, to cause the authentication server 300 to perform user authentication. Then, the authentication requesting unit 132 receives the authentication result of user authentication from the authentication server 300.

The communication unit 133 communicates with the IC card management server 200 (the communication unit 201) via the network 122, to transmit and receive various kinds of data (for example, an authentication request for IC card authentication, an IC authentication result of card authentication, a registration request for IC card information, and registration result of IC card information, etc.) with the IC card management server 200.

Furthermore, the communication unit 133 communicates with the authentication server 300 (the communication unit 301) via the network 122, to transmit and receive various kinds of data (for example, an authentication request for user authentication and an authentication result of user authentication, etc.) with the authentication server 300.

The user information accepting unit 134 instructs the UI unit 111 to display a user information input screen (an example of a “first screen” according to an embodiment of the present invention). That is, the user information accepting unit 134 functions as a “first display control unit” according to an embodiment of the present invention. Then, the user information accepting unit 134 receives, from the UI unit 111, the user information (user ID and password) input from the input screen, to accept input of the user information.

The login control unit 135 allows the user to log into the image processing apparatus 100 when the authentication result of the user authentication by the authentication requesting unit 132 is “successful”. Accordingly, the user can use one or more image processing functions (for example, a copy function, a scan function, a fax function, and a printer function, etc.) of the image processing apparatus 100.

The registration control unit 136 controls registration of the IC card information of an unregistered IC card, in the IC card management server 200. Specifically, when the login control unit 135 allows the login of the user to the image processing apparatus 100, the registration control unit 136 determines whether the IC card information is held in the first holding unit 140. Here, when the registration control unit 136 determines that the IC card information is “held”, the registration control unit 136 instructs the UI unit 111 to display a confirmation screen (an example of a “second screen” according to an embodiment of the present invention) for confirming whether to register the IC card information of the unregistered IC card. That is, the registration control unit 136 functions as a “second display control unit” according to an embodiment of the present invention. Then, the registration control unit 136 receives, from the UI unit 111, a confirmation result indicating whether to register the IC card information, input from the confirmation screen. When the confirmation result is “register”, the registration control unit 136 transmits, to the IC card management server 200 via the communication unit 133, a registration request including the IC card information (card ID) of the unregistered IC card held in the first holding unit 140 and the user ID input from the UI unit 111. In response to the registration request, an IC card information registering unit 204 of the IC card management server 200 registers the IC card information in an IC card information table, in association with the user ID.

The first holding unit 140 holds (stores) the IC card information (card ID) of the unregistered IC card. For example, when the IC card authentication of the unregistered IC card by the IC card management server 200 is unsuccessful, the first holding unit 140 holds the IC card information (card ID) of the unregistered IC card.

### Functional Configuration of IC Card Management Server 200—First Embodiment

As illustrated in FIG. 3, the IC card management server 200 includes a communication unit 201, an IC card authenticating unit 202, a card information storage unit 203, and the IC card information registering unit 204 as functional units.

The communication unit 201 communicates with the image processing apparatus 100 (the communication unit 133) via the network 122, to transmit and receive various kinds of data (for example, an authentication request for IC card authentication, an authentication result of IC card authentication, a registration request for IC card information, and a registration result of IC card information, etc.) with the image processing apparatus 100.

The IC card authenticating unit 202 performs IC card authentication in response to an authentication request for IC card authentication, transmitted from the image processing apparatus 100. Specifically, the IC card authenticating unit 202 determines whether IC card information, which matches the IC card information (card ID) included in the authentication request, is registered in the IC card information table stored in the card information storage unit 203. Then, when the IC card authenticating unit 202 determines that “matching IC card information is not registered”, the IC card authenticating unit 202 transmits information indicating “unsuccessful” as the authentication result of IC card authentication, to the image processing apparatus 100. Conversely, when the IC card authenticating unit 202 determines that “matching IC card information is registered”, the IC card authenticating unit 202 transmits information indicating “successful” as the authentication result of IC card authentication, to the image processing apparatus 100.

The card information storage unit 203 stores IC card information used for IC card authentication. Specifically, the card information storage unit 203 stores an IC card information table for managing a plurality of pieces of IC card information. The IC card information table will be described later with reference to FIGS. 5A and 5B.

The IC card information registering unit 204 registers the IC card information in response to a registration request of IC card information transmitted from the image processing apparatus 100. Specifically, when the communication unit 201 receives the IC card information registration request, the IC card information registering unit 204 registers the IC card information included in the registration request in association with the user ID included in the registration request, in the IC card information table. Then, the IC card information registering unit 204 transmits the registration result of the IC card information to the image processing apparatus 100 via the communication unit 201.

### Functional Configuration of Authentication Server 300—First Embodiment

As illustrated in FIG. 3, the authentication server 300 includes a communication unit 301, a user authenticating unit 302, and an authentication information storage unit 303 as functional units.

The communication unit 301 communicates with the image processing apparatus 100 (the communication unit 133) via the network 122, to transmit and receive various kinds of data (for example, an authentication request for user authentication and an authentication result of user authentication, etc.) with the image processing apparatus 100.

The user authenticating unit 302 performs user authentication in response to an authentication request for user authentication transmitted from the image processing apparatus 100. Specifically, the user authenticating unit 302 determines whether user information, which matches the user information included in the authentication request (combination of user ID and password), is registered in the user information table stored in the authentication information storage unit 303. Then, when the user authenticating unit 302 determines that “matching user information is not registered”, the user authenticating unit 302 transmits information indicating “unsuccessful” as the authentication result of user authentication, to the image processing apparatus 100. Conversely, when the user authenticating unit 302 determines that “matching user information is registered”, the user authenticating unit 302 transmits information indicating “successful” as the authentication result of user authentication, to the image processing apparatus 100.

The authentication information storage unit 303 stores user information used for user authentication. Specifically, the authentication information storage unit 303 stores a user information table for managing a plurality of pieces of user information. The user information table will be described later with reference to FIGS. 5A and 5B.

The respective functions of the image processing apparatus 100, the IC card management server 200, or the authentication server 300 are implemented by various hardware elements (see FIG. 2) provided in the image processing apparatus 100, the IC card management server 200, or the authentication server 300. For example, the authentication information reading unit 121 is implemented by the reading device 120. Furthermore, the UI unit 111 is implemented by the operation panel 15. Furthermore, the storage units are implemented by various storage devices (ROM, RAM, flash memory, and HDD, etc.). Furthermore, the communication units are implemented by various communication I/Fs.

Furthermore, the functions of performing various kinds of control and arithmetic processing are implemented as the CPU executes programs stored in various storage devices. These program may be installed in advance in the image processing apparatus 100, the IC card management server 200, or the authentication server 300, or may be provided from outside and installed in the image processing apparatus 100, the IC card management server 200, or the authentication server 300. In the latter case, these programs may be provided by an external storage medium (for example, a USB memory, a memory card, and a compact disc-read-only memory (CD-ROM), etc.) or may be provided by being downloaded from a server on a network (for example, the Internet, etc.).

Note that the functions of the image processing apparatus 100, the IC card management server 200, and the authentication server 300 are sufficient as long as the functions are implemented as functions of the management system 10 as a whole, that is, the functions may be implemented by other apparatuses provided in the management system 10.

### Procedure of Processing by Management System 10—First Embodiment

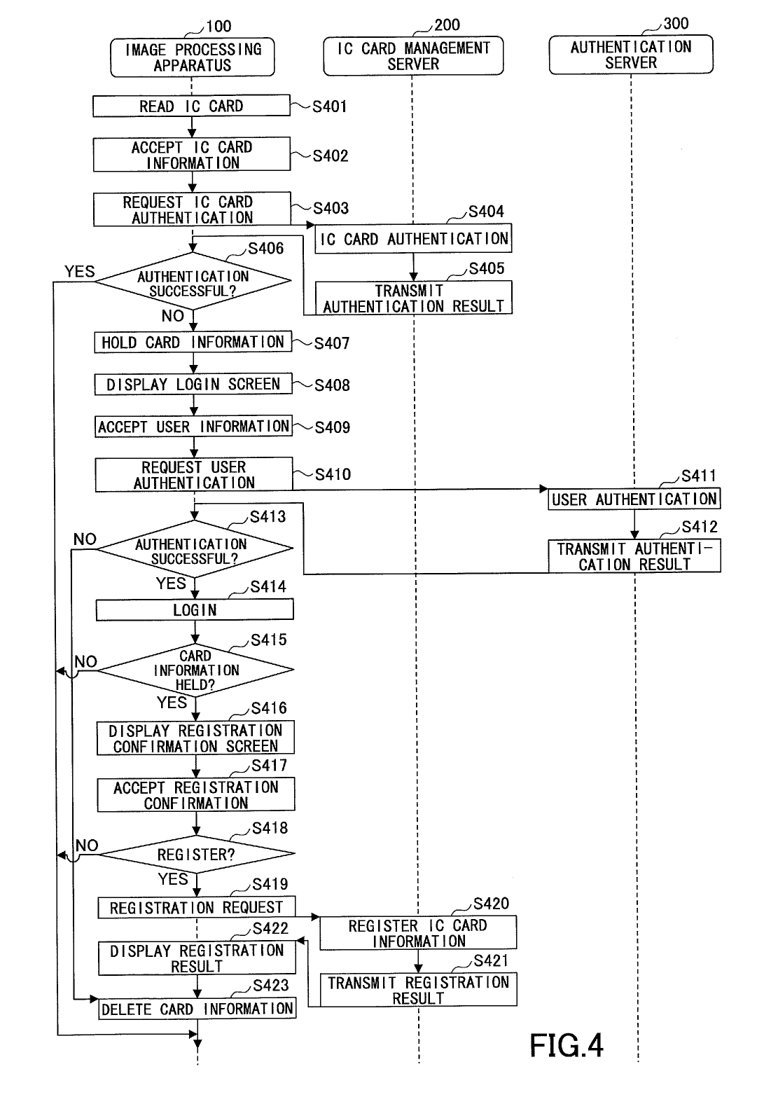

FIG. 4 is a sequence diagram illustrating a procedure of processes by the management system 10 according to the first embodiment of the present invention.

First, in the image processing apparatus 100, the authentication information reading unit 121 reads the IC card information from the IC card possessed by the user (step S401). Then, the card information accepting unit 131 receives the IC card information read in step S401, from the authentication information reading unit 121, thereby accepting input of the IC card information (step S402). Furthermore, the authentication requesting unit 132 transmits an authentication request including the IC card information accepted in step S402, to the IC card management server 200 via the communication unit 133 (step S403).

In the IC card management server 200, when the communication unit 201 receives the authentication request transmitted in step S403, the IC card authenticating unit 202 performs IC card authentication based on the IC card information included in the authentication request (step S404). Then, the IC card authenticating unit 202 transmits the authentication result of the IC card authentication in step S404, to the image processing apparatus 100 via the communication unit 201 (step S405).

Subsequently, in the image processing apparatus 100, the authentication requesting unit 132 receives the authentication result transmitted in step S405 via the communication unit 133. When the authentication result of the IC card is “unsuccessful” (step S406: NO), the authentication requesting unit 132 causes the first holding unit 140 to hold the IC card information accepted in step S402 (step S407). Then, the image processing apparatus 100 proceeds to step S408. Conversely, when the authentication result of the IC card is “successful” (step S406: YES), the authentication requesting unit 132 does not cause the first holding unit 140 to hold the IC card information. Then, the management system ends the series of processes illustrated in FIG. 4.

In step S408, according to an instruction from the user information accepting unit 134, the UI unit 111 displays an input screen (login screen) of user information (user ID and password). Then, the user information accepting unit 134 receives, from the UI unit 111, the user information (user ID and password) input from the input screen, thereby accepting input of the user information (step S409). Furthermore, the authentication requesting unit 132 transmits an authentication request including the user information accepted in step S409, to the authentication server 300 via the communication unit 133 (step S410).

In the authentication server 300, when the communication unit 301 receives the authentication request transmitted in step S410, the user authenticating unit 302 performs user authentication based on the user information included in the authentication request (step S411). Then, the user authenticating unit 302 transmits the authentication result of the user authentication in step S411, to the image processing apparatus 100 via the communication unit 301 (step S412).

In the image processing apparatus 100, the authentication requesting unit 132 receives the authentication result transmitted in step S410 via the communication unit 133. Here, when the authentication result of the user information is “unsuccessful” (step S413: NO), the authentication requesting unit 132 deletes the IC card information held in the first holding unit 140 (step S423). Then, the management system 10 ends the series of processes illustrated in FIG. 4. Conversely, when the authentication result of the user information is “successful” (step S413: YES), the login control unit 135 allows the user to log into the image processing apparatus 100 (step S414).

In response to the user's login being allowed in step S414, the registration control unit 136 determines whether the first holding unit 140 holds the IC card information (step S415). Here, when the registration control unit 136 determines that the IC card information is “held” (step S415: YES), the registration control unit 136 instructs the UI unit 111 to display a confirmation screen for confirming whether to register the IC card information. In response to this instruction, the UI unit 111 displays a confirmation screen for confirming whether to register IC card information (step S416). Then, the image processing apparatus 100 proceeds to step S417. Conversely, when the registration control unit 136 determines that the IC card information is “not held” (step S415: NO), the registration control unit 136 does not instruct the displaying of the confirmation screen, and the management system 10 ends the series of processes illustrated in FIG. 4.

In step S417, the registration control unit 136 receives, from the UI unit 111, the confirmation result as to whether to register the IC card information, input from the UI unit 111, thereby accepting input of the confirmation result. Here, when the confirmation result is “do not register” (step S418: NO), the management system 10 ends the series of processes illustrated in FIG. 4. Conversely, when the confirmation result is “register” (step S418: YES), the registration control unit 136 transmits a registration request including the IC card information held in the first holding unit 140 and the user ID input from the UI unit 111, to the IC card management server 200 via the communication unit 133 (step S419).

In the IC card management server 200, when the communication unit 201 receives the registration request transmitted in step S419, the IC card information registering unit 204 registers the IC card information included in the registration request in association with the user ID included in the registration request, in the IC card information table stored in the card information storage unit 203 (step S420). Then, the IC card information registering unit 204 transmits the registration result of the IC card information in step S420, to the image processing apparatus 100 via the communication unit 201 (step S421).

In the image processing apparatus 100, when the registration control unit 136 receives the registration result transmitted in step S416 via the communication unit 133, the UI unit 111 displays the registration result, according to an instruction from the registration control unit 136 (Step S422). When the registration result is “successful”, the registration control unit 136 deletes the IC card information held in the first holding unit 140 (step S423). However, when the registration result is “unsuccessful”, the deletion process of step S423 is skipped. Then, the management system 10 ends the series of processes illustrated in FIG. 4. Note that the deletion process in step S423 may be performed before displaying the registration result in step S422.

### Examples of User Information Table and IC Card Information Table—First Embodiment

FIGS. 5A and 5B are diagrams illustrating examples of a user information table and an IC card information table according to the first embodiment of the present invention.

FIG. 5A is a diagram illustrating an example of the user information table stored in the authentication information storage unit 303 of the authentication server 300. As illustrated in FIG. 5A, in the user information table, a plurality of pieces of user information are managed. In the example illustrated in FIG. 5A, the user information includes “user ID”, “password”, “mail address”, and “fax destination”, etc., as data items. For example, in the user information table, the user information is registered in advance by the administrator. This user information table is referred to by the user authenticating unit 302 and used for user authentication. The user information table is used not only for user authentication at the time of logging in to the image processing apparatus 100, but may also be used for user authentication at a plurality of information processing apparatuses (for example, personal computers, etc.) connected to the network 122.

FIG. 5B is a diagram illustrating an example of the IC card information table stored in the card information storage unit 203 of the IC card management server 200. As illustrated in FIG. 5B, in the IC card information table, a plurality of pieces of IC card information are managed. In the example illustrated in FIG. 5B, the IC card information includes “card ID”, “user ID”, “valid/invalid”, and “expiration date”, etc., as data items. For example, in the ID card information table, the IC card information is registered in advance by the administrator.

Alternatively, as described in FIG. 4, in the ID card information table, when the user is “successful” in the user authentication with the user information after the user has been “unsuccessful” in the IC card authentication with an unregistered IC card, and succeeds to log into the image processing apparatus 100, the user can register the IC card information of the unregistered IC card, from the image processing apparatus 100. In this case, the card ID read from the unregistered IC card is set in “card ID”. In “user ID”, the user ID input when the user successfully logs in, is set. Furthermore, for example, “valid” may be automatically set in “valid/invalid”. Furthermore, for example, the expiration date preset in the system may be automatically set in the “expiration date”, or the date after a predetermined period from the present system date may be automatically set.

This IC card information table is referred to by the IC card authenticating unit 202 and is used for IC card authentication. Note that the IC card information table is not only used for IC card authentication at the time of logging into the image processing apparatus 100, but also for IC card authentication at a plurality of information processing apparatuses (for example, personal computers etc.) connected to the network 122.

### Example of Transition of Display Screen—First Embodiment

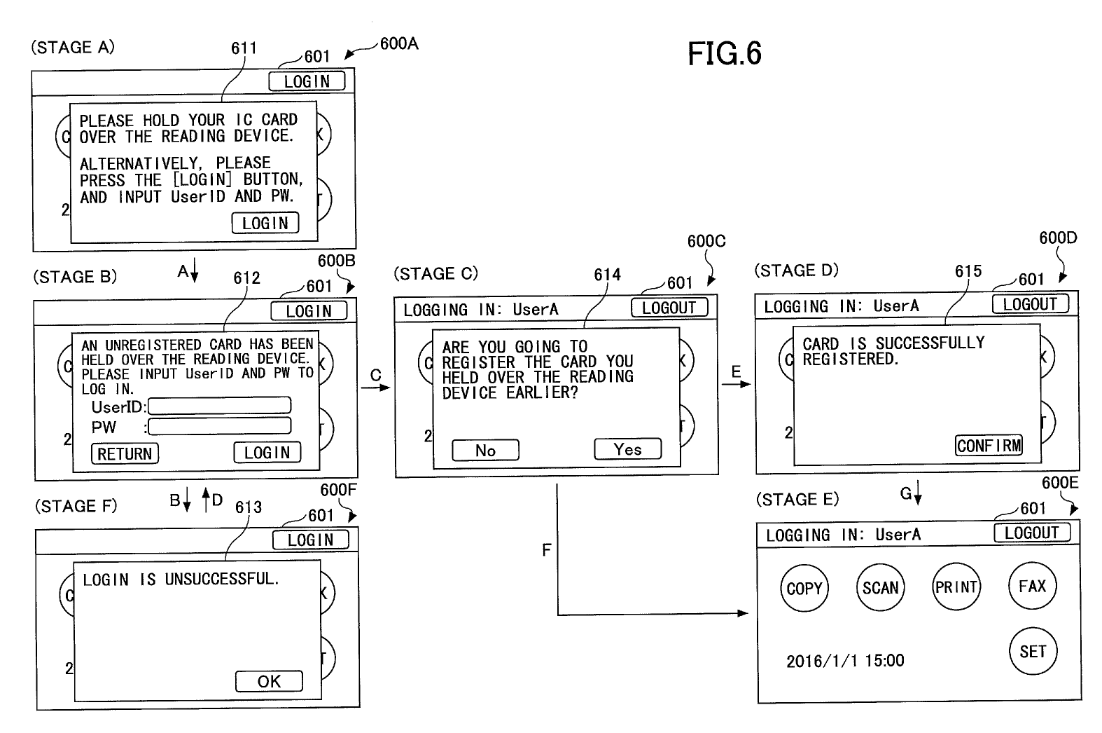

FIG. 6 is a diagram illustrating a transition example of the display screen in the image processing apparatus 100 according to the first embodiment of the present invention.

A display screen 600A illustrated in FIG. 6 (STAGE A) is an initial screen displayed by the UI unit 111 of the image processing apparatus 100. The display screen 600A includes a menu screen 601 and a pop-up screen 611 displayed in an overlapping manner on the menu screen 601. The pop-up screen 611 indicates a message of contents requesting the user to perform a login operation. That is, at this time point, the image processing apparatus 100 cannot use the menu screen 601 because the user has not logged in. Similarly, hereinafter, the menu screen 601 cannot be used until the login of the user is allowed. Here, when the user holds the IC card over the reading device 120 in response to the message of the pop-up screen 611, the IC card management server 200 performs the IC card authentication. At this time, when the authentication result of the IC card authentication is “unsuccessful”, the display screen displayed by the UI unit 111 transitions to a display screen 600B illustrated in FIG. 6 (STAGE B) (arrow A in FIG. 6).

The display screen 600B illustrated in FIG. 6 (STAGE B) includes the menu screen 601 and a pop-up screen 612 displayed in an overlapping manner on the menu screen 601. The pop-up screen 612 is an input screen (login screen) of user information (user ID and password). Here, when the user inputs the user ID and the password in the pop-up screen 612 and presses the “login” button, the user authentication is performed by the authentication server 300. At this time, when the authentication result of the user authentication is “unsuccessful”, the display screen displayed by the UI unit 111 transitions to a display screen 600F illustrated in FIG. 6 (STAGE F) (arrow B in FIG. 6). Conversely, when the authentication result of the user authentication is “successful”, the login of the user is allowed and the display screen displayed by the UI unit 111 transitions to a display screen 600C illustrated in FIG. 6 (STAGE C) (arrow C in FIG. 6).

The display screen 600F illustrated in FIG. 6 (STAGE F) includes the menu screen 601 and a pop-up screen 613 displayed in an overlapping manner on the menu screen 601. The pop-up screen 613 indicates a message that the login (user authentication) has been unsuccessful. Here, when the user presses the “OK” button, the display screen displayed by the UI unit 111 transitions to the display screen 600B illustrated in FIG. 6 (STAGE B) (arrow D in FIG. 6). That is, since the display screen 600B is displayed again, the user can re-input the user ID and password without holding the IC card over the reading device 120 again. However, the present invention is not limited as such. For example, the display screen displayed by the UI unit 111 may transition to the display screen 600A illustrated in FIG. 6 (STAGE A) and the user may be requested to hold the IC card over the reading device 120 again.

The display screen 600C illustrated in FIG. 6 (STAGE C) includes the menu screen 601 and a pop-up screen 614 displayed in an overlapping manner on the menu screen 601. The pop-up screen 614 is a confirmation screen for confirming whether to register IC card information. Here, when the user presses the “YES” button, the IC card information is registered in the IC card management server 200. In response to this, the display screen displayed by the UI unit 111 transitions to a display screen 600D as illustrated in FIG. 6 (STAGE D) (arrow E in FIG. 6). Conversely, when the user presses the “NO” button, the IC card information is not registered and the display screen displayed by the UI unit 111 transitions to a display screen 600E illustrated in FIG. 6 (STAGE A) (arrow F in FIG. 6).

The display screen 600D illustrated in FIG. 6 (STAGE D) includes the menu screen 601 and a pop-up screen 615 displayed in an overlapping manner on the menu screen 601. The pop-up screen 615 is a registration result display screen indicating that the registration of the IC card information is successful. Here, when the user presses the “confirm” button, the display screen displayed by the UI unit 111 transitions to the display screen 600E illustrated in FIG. 6 (STAGE E) (arrow G in FIG. 6).

The display screen 600E illustrated in FIG. 6 (STAGE E) includes only the menu screen 601. In the menu screen 601, icons of one or more image processing functions (copy function, scan function, print function, and fax function) usable by the user are displayed, and the user can select any one of these image processing functions by selecting the icon of the corresponding image processing function in the menu screen 601, to use the image processing function.

As described above, according to the image processing apparatus 100 according to the first embodiment of the present invention, when the IC card authentication of the unregistered IC card is unsuccessful, user authentication is performed with the user information, and when this user authentication is successful, the user is allowed to log in, and a confirmation screen as to whether to register the unregistered IC card is displayed, to confirm with the user. When the user instructs to “register”, the unregistered IC card is registered. That is, according to the management system 10 according to the first embodiment of the present invention, after the user registers the IC card information, it is not necessary to hold the IC card over the reading device 120 again or to input the user information again, to use the image processing functions of the image processing apparatus 100. Therefore, the user can easily register the IC card and use the image processing apparatus 100.

### Second Embodiment

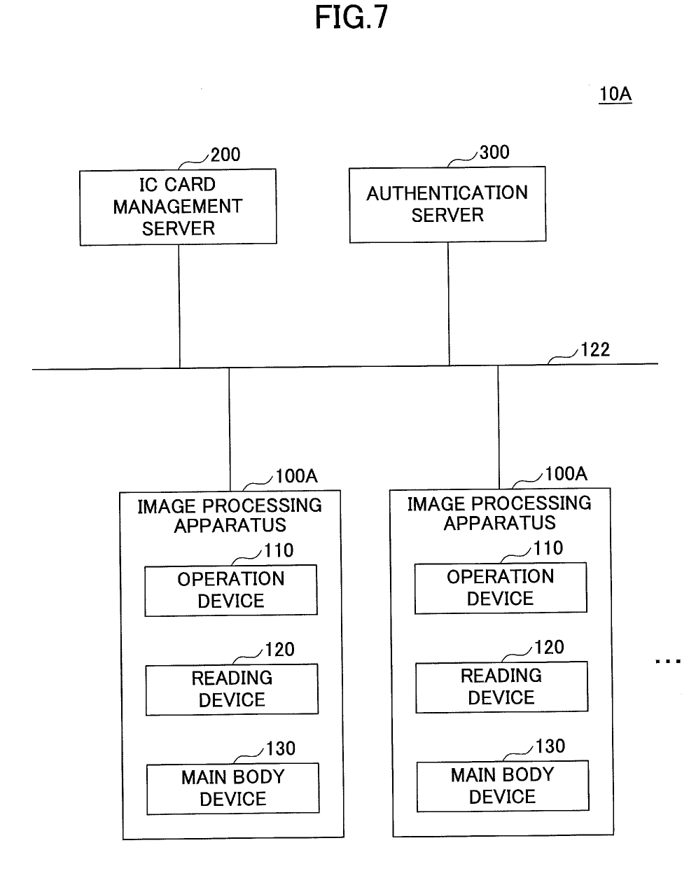

Next, a second embodiment of the present invention will be described with reference to FIGS. 7 to 12. Only the differences from the first embodiment will be described below.

### Configuration of Management System 10A—Second Embodiment

FIG. 7 is a diagram illustrating the configuration of a management system 10A according to the second embodiment of the present invention. The management system 10A according to the second embodiment is different from the management system 10 (see FIG. 1) according to the first embodiment in that a plurality of image processing apparatuses 100A are provided instead of the plurality of image processing apparatuses 100.

### Functional Configuration of Management System 10A—Second Embodiment

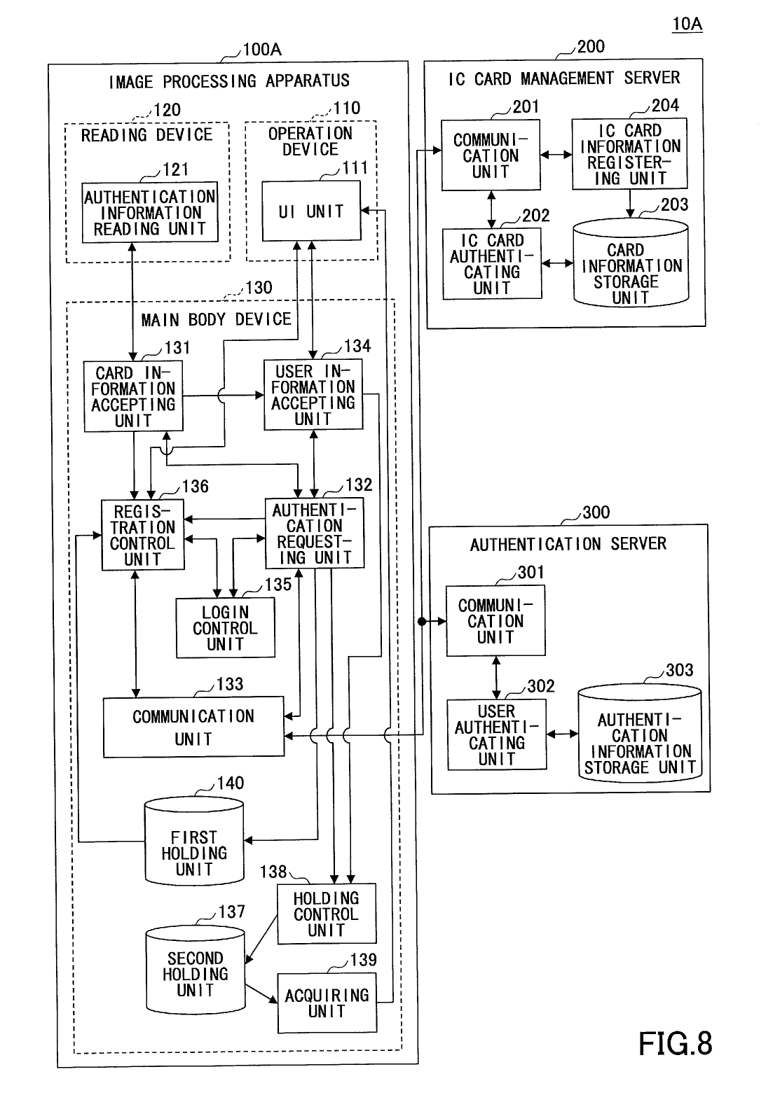

FIG. 8 is a functional block diagram of the management system 10A according to the second embodiment of the present invention. As illustrated in FIG. 8, the image processing apparatus 100A according to the second embodiment is different from the image processing apparatus 100 according to the first embodiment in that the image processing apparatuses 100A further includes a second holding unit 137, a holding control unit 138, and an acquiring unit 139.

The holding control unit 138 causes the second holding unit 137 to hold unregistered IC card information. The second holding unit 137 holds (stores) unregistered IC card information. The unregistered IC card information is an example of “association information” according to an embodiment of the present invention. The unregistered IC card information includes a card ID of an unregistered IC card and user information input by the user when this unregistered IC card is used (however, this user information is limited to the user information input when the user authentication is “successful”), in association with each other.

When the IC card authentication of the unregistered IC card is “unsuccessful”, and the unregistered IC card information corresponding to the IC card information is held in the second holding unit 137, the acquiring unit 139 acquires the unregistered IC card information, and automatically inputs the user information set in the unregistered IC card information, to an input field of the user information input screen.

### Procedure 1 of Processes by Management System 10A—Second Embodiment

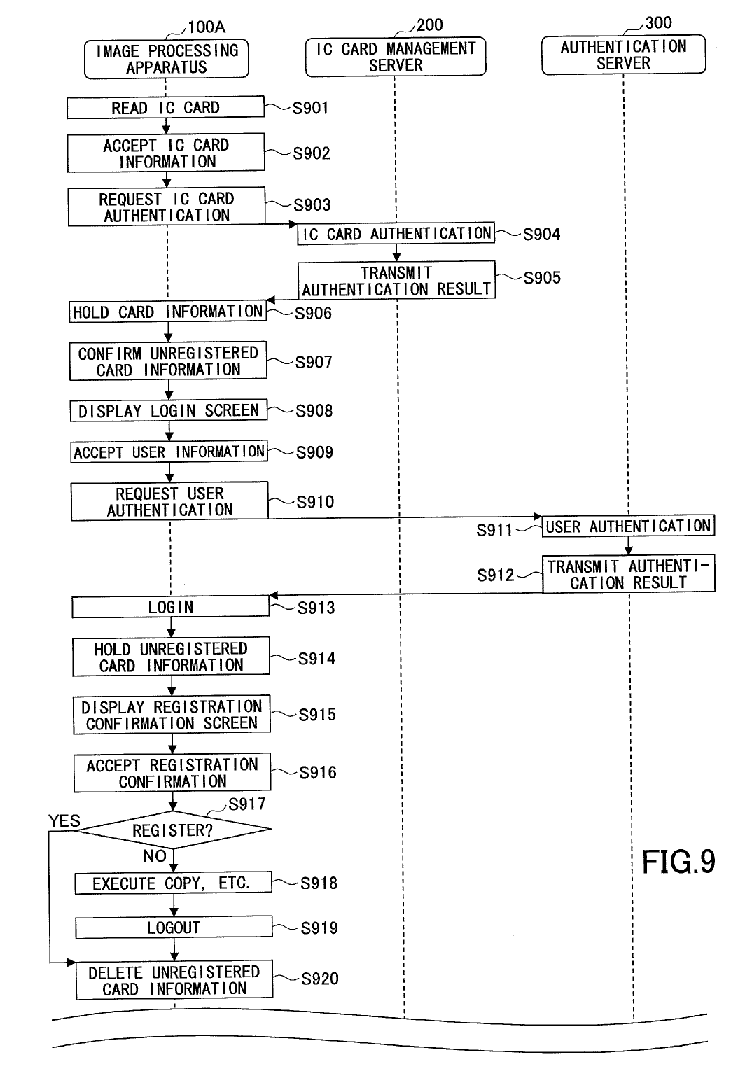

FIG. 9 is a sequence diagram illustrating a procedure of processes by the management system 10A according to the second embodiment of the present invention. Here, the procedure of processes by the management system 10A before the unregistered IC card information is held, will be described.

First, in the image processing apparatus 100A, the authentication information reading unit 121 reads the IC card information from the IC card possessed by the user (step S901). Then, the card information accepting unit 131 receives the IC card information read in step S901, from the authentication information reading unit 121, thereby accepting input of the IC card information (step S902). Furthermore, the authentication requesting unit 132 transmits an authentication request including the IC card information accepted in step S902, to the IC card management server 200 via the communication unit 133 (step S903).

In the IC card management server 200, when the communication unit 201 receives the authentication request transmitted in step S903, the IC card authenticating unit 202 performs IC card authentication based on the IC card information included in the authentication request (step S904). Then, the IC card authenticating unit 202 transmits the authentication result of the IC card authentication in step S904, to the image processing apparatus 100A via the communication unit 201 (step S905). Hereinafter, the processing procedure will be described assuming that the authentication result of the IC card authentication is “unsuccessful”.

In the image processing apparatus 100A, when the authentication requesting unit 132 receives the authentication result transmitted in step S905 via the communication unit 133, the authentication requesting unit 132 stores the IC card information accepted in step S902, in the first holding unit 140 (step S906). Then, the acquiring unit 139 confirms whether the unregistered IC card information relating to the IC card information (card ID) accepted in step S902, is held in the second holding unit 137 (step S907). Here, the following processing procedure will be described assuming that it has been confirmed as “unregistered IC card information is not held”.

Then, according to an instruction from the user information accepting unit 134, the UI unit 111 displays an input screen (login screen) of the user information (user ID and password) (step S908). At this time, since it is confirmed in step S907 that “unregistered IC card information is not held”, the acquiring unit 139 leaves the input field of user information on the input screen in a blank state. Then, the user information accepting unit 134 receives, from the UI unit 111, the user information (user ID and password) input from the input screen, thereby accepting input of the user information (step S909). Furthermore, the authentication requesting unit 132 transmits an authentication request including the user information accepted in step S909, to the authentication server 300 via the communication unit 133 (step S910).

In the authentication server 300, when the communication unit 301 receives the authentication request transmitted in step S910, the user authenticating unit 302 performs user authentication based on the user information included in the authentication request (step S911). Then, the user authenticating unit 302 transmits the authentication result of user authentication of step S911, to the image processing apparatus 100A via the communication unit 301 (step S912). In the following, the processing procedure will be described assuming that the authentication result of user authentication is “successful”.

In the image processing apparatus 100A, when the authentication requesting unit 132 receives the authentication result transmitted in step S911 via the communication unit 133, the login control unit 135 allows the user to log into the image processing apparatus 100A (step S913). In response to the login, the holding control unit 138 associates the IC card information (card ID) held in the first holding unit 140 with the user information (user ID) accepted in step S909, and stores this information as unregistered IC card information in the second holding unit 137 (step S914).

Then, according to an instruction from the registration control unit 136, the UI unit 111 displays a confirmation screen for confirming whether to register the IC card information (step S915). Then, the registration control unit 136 receives, from the UI unit 111, the confirmation result as to whether to register the IC card information input from the confirmation screen, thereby accepting the input of the confirmation result (step S916).

Here, when the confirmation result is “do not register” (step S917: NO), the image processing apparatus 100A subsequently executes various image processing functions such as copying, in accordance with an execution instruction from the user (step S918), and causes the user to log out from the image processing apparatus 100A in response to a logout operation from the user (step S919). Then, the management system 10A ends the series of processes illustrated in FIG. 9.

Conversely, when the confirmation result is “register” (step S917: NO), the holding control unit 138 deletes the unregistered IC card information held in the second holding unit 137 (step S920). Then, the management system 10 executes the processes of steps S419 and beyond illustrated in FIG. 4.

### Procedure 2 of Processes by Management System 10A—Second Embodiment

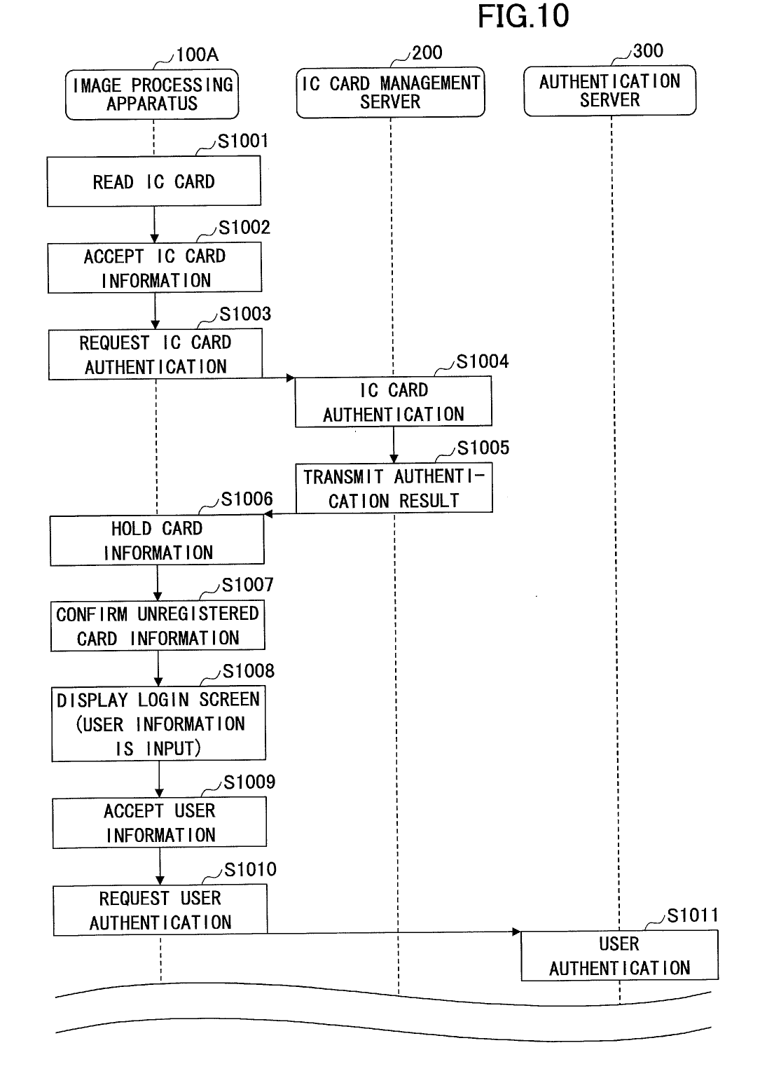

FIG. 10 is a sequence diagram illustrating a procedure of processes by the management system 10A according to the second embodiment of the present invention. Here, a procedure of processes by the management system 10A after holding the unregistered IC card information, will be described.

First, in the image processing apparatus 100A, the authentication information reading unit 121 reads the IC card information from the IC card possessed by the user (step S1001). Then, the card information accepting unit 131 receives the IC card information read in step S1001, from the authentication information reading unit 121, thereby accepting input of the IC card information (step S1002). Furthermore, the authentication requesting unit 132 transmits an authentication request including the IC card information accepted in step S1002, to the IC card management server 200 via the communication unit 133 (step S1003).

In the IC card management server 200, when the communication unit 201 receives the authentication request transmitted in step S1003, the IC card authenticating unit 202 performs IC card authentication based on the IC card information included in the authentication request (step S1004). Then, the IC card authenticating unit 202 transmits the authentication result of the IC card authentication in step S1004, to the image processing apparatus 100A via the communication unit 201 (step S1005). Hereinafter, the processing procedure will be described assuming that the authentication result of the IC card authentication is “unsuccessful”.

In the image processing apparatus 100A, when the authentication requesting unit 132 receives the authentication result transmitted in step S1005 via the communication unit 133, the authentication requesting unit 132 stores the IC card information accepted in step S1002, in the first holding unit 140 (step S1006). Then, the acquiring unit 139 confirms whether the unregistered IC card information relating to the IC card information (card ID) accepted in step S1002, is held in the second holding unit 137 (step S1007). Here, the following processing procedure will be described assuming that it has been confirmed as “unregistered IC card information is held”.

Then, according to an instruction from the user information accepting unit 134, the UI unit 111 displays an input screen (login screen) of user information (user ID and password) (step S1008). At this time, since it is confirmed in step S1007 that “unregistered IC card information is held”, the acquiring unit 139 automatically inputs the user ID included in the unregistered IC card information, in the input field of the user information (user ID) in the input screen. Then, the user information accepting unit 134 receives, from the UI unit 111, the user information (user ID and password) input from the input screen, thereby accepting input of the user information (step S1009). Furthermore, the authentication requesting unit 132 transmits an authentication request including the user information accepted in step S1009, to the authentication server 300 via the communication unit 133 (step S1010).

In the authentication server 300, when the communication unit 301 receives the authentication request transmitted in step S1010, the user authenticating unit 302 performs user authentication based on the user information included in the authentication request (step S1011). Since the subsequent processes overlap with the processes described above, a description thereof will be omitted.

### Example of Unregistered IC Card Information—Second Embodiment

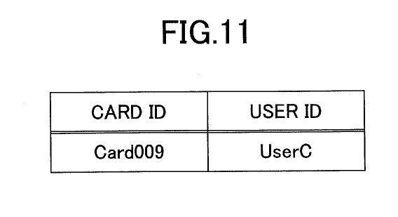

FIG. 11 is a diagram illustrating an example of unregistered IC card information according to the second embodiment of the present invention. FIG. 11 is a diagram illustrating an example of unregistered IC card information held in the second holding unit 137. As illustrated in FIG. 11, the unregistered IC card information includes “card ID” and “user ID” as data items. In the “card ID”, the card ID of the unregistered IC card is set. In “user ID”, a user ID (however, limited to a user ID for which user authentication has been “successful”) input by the user of the unregistered IC card, is set.

### Display Example of Display Screen—Second Embodiment

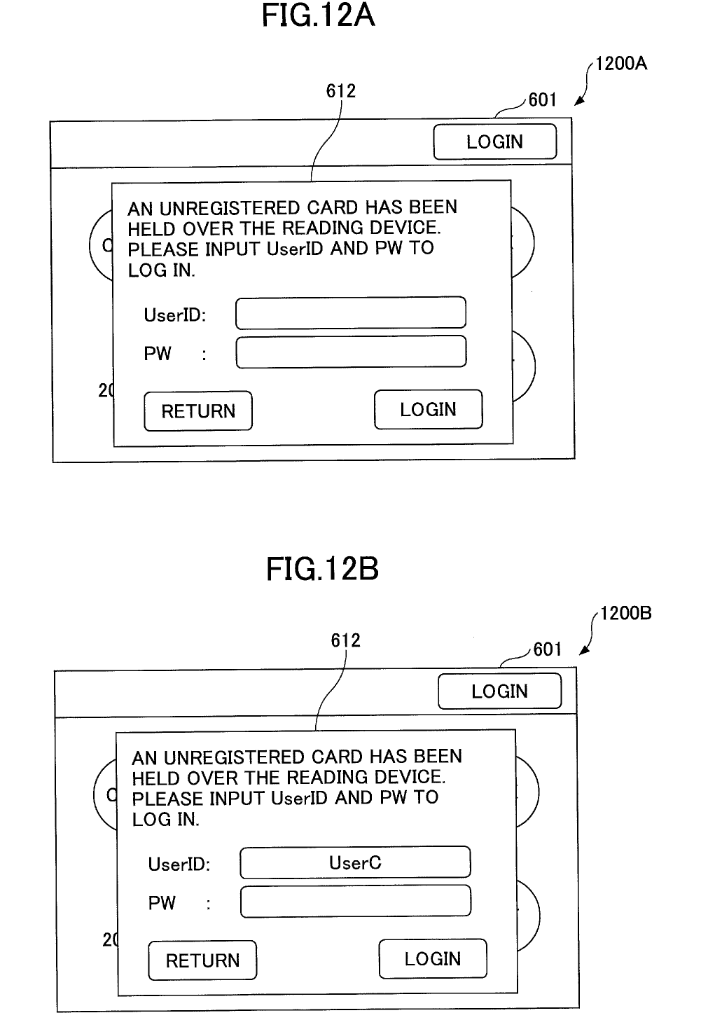

FIGS. 12A and 12B are diagrams illustrating display examples of a display screen in the image processing apparatus 100A according to the second embodiment of the present invention.

Both of a display screen 1200A illustrated in FIG. 12A and a display screen 1200B illustrated in FIG. 12B are display screens displayed by the UI unit 111 when an unregistered IC card is held over the reading device 120, similar to the display screen 600B illustrated in FIG. 6 (STAGE B). Both of the display screens 1200A and 1200B include the menu screen 601 and the pop-up screen 612 displayed in an overlapping manner on the menu screen 601, similar to the display screen 600B illustrated in FIG. 6 (STAGE B).

However, the display screen 1200A is a display example when the unregistered IC card information is not held in the second holding unit 137 (that is, at the time of the first login), and the input field of the user ID in the pop-up screen 612 remains blank. On the other hand, the display screen 1200B is a display example when the unregistered IC card information is held in the second holding unit 137 (that is, at the time of second and subsequent logins), and a user ID “User C” is automatically input in the input field of the user ID in the pop-up screen 612. This user ID is the user ID set in the unregistered IC card information (see FIG. 11) held in the second holding unit 137. In this way, when the unregistered IC card information is held, the user ID is automatically input, and therefore the user only needs to input the password.

As described above, according to the image processing apparatus 100A according to the second embodiment of the present invention, the user ID at the time of successful user authentication is held in association with the card ID of the unregistered IC card, in the second holding unit 137. Accordingly, when the user uses the unregistered IC card to use the image processing apparatus 100A thereafter, the user ID can be automatically input in the input field of the login screen. Therefore, it is possible to reduce the work of inputting login information by the user. Note that the unregistered IC card information may further include a “password” of the user information in addition to the “user ID” of the user information. Accordingly, not only “user ID” but also “password” can be automatically input in the input field of the login screen. Therefore, it is possible to further reduce the work of inputting login information by the user.

Note that in the second embodiment, the second holding unit 137 is provided in the image processing apparatus 100A; however, the second holding unit 137 may be provided in an external device (for example, the IC card management server 200). In this case, when unregistered IC card information is registered from any one of the image processing apparatuses 100A, it is possible to use unregistered IC card information from each of the plurality of image processing apparatuses 100 A thereafter.

Also, when holding the unregistered IC card information in the second holding unit 137, it may be confirmed by the user whether to hold the unregistered IC card information, and only when instructed to “hold” by the user, the second holding unit 137 may store the registered IC card information.

Furthermore, in the example of FIG. 9, the unregistered IC card information is held immediately after the user's login is allowed. However, it is also possible to hold the unregistered IC card information at another timing (for example, at the timing immediately after the IC card information of the unregistered IC card is selected as “do not register” by the user (that is, the timing immediately after being determined as NO in step S917).

### Third Embodiment

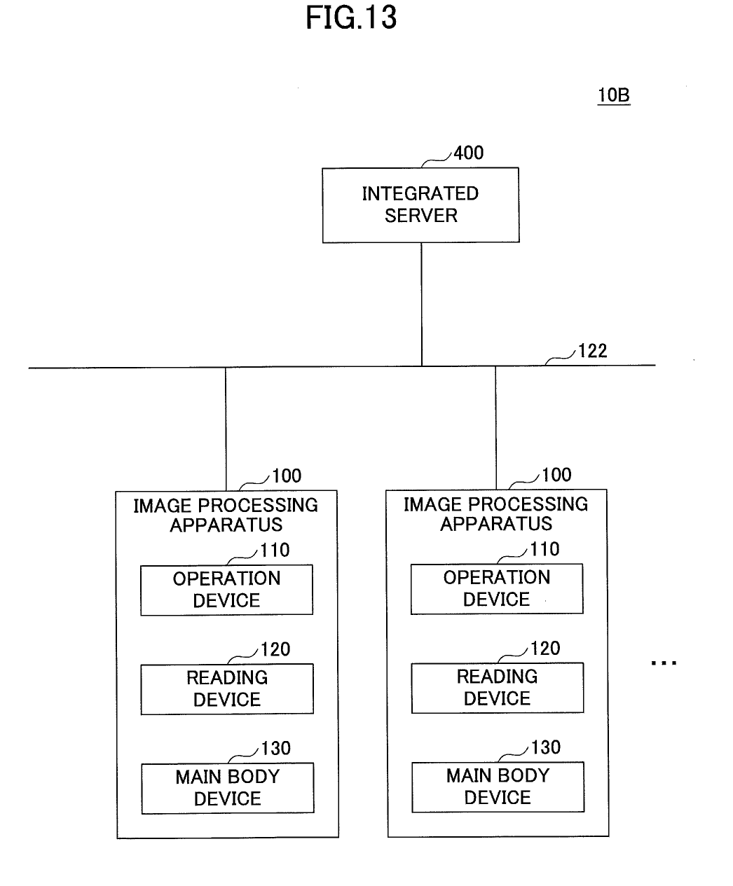

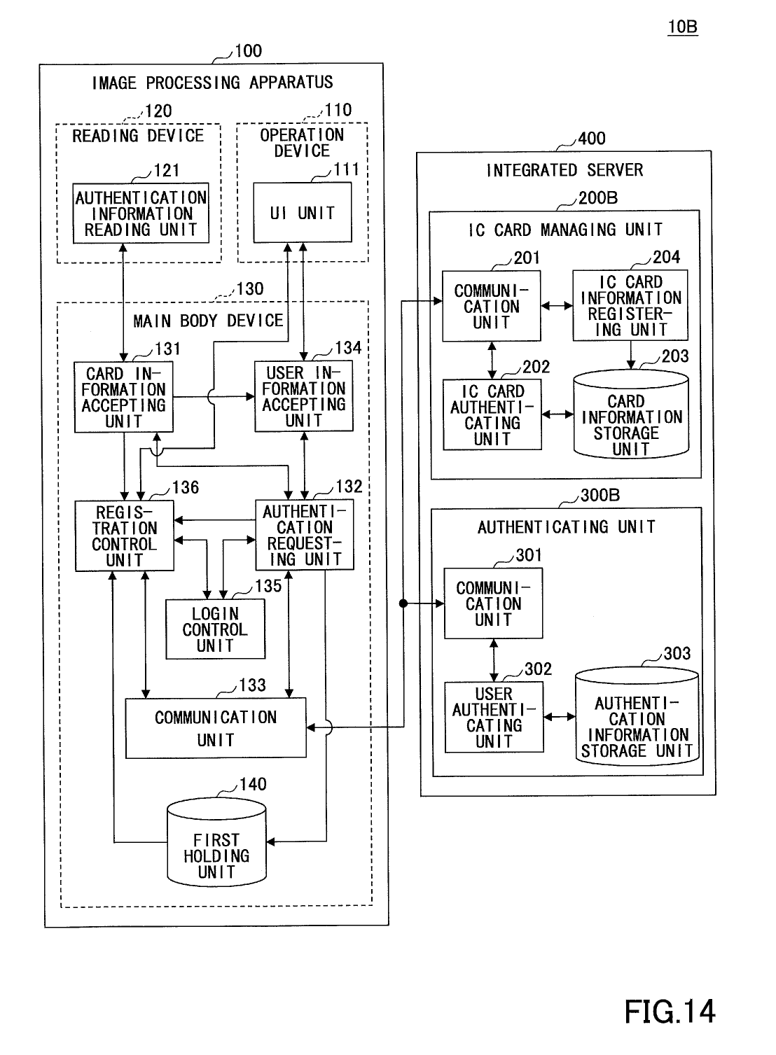

Next, a third embodiment of the present invention will be described with reference to FIGS. 13 and 14. Only the differences from the first embodiment will be described below.

### Configuration of Management System 10B—Third Embodiment

FIG. 13 is a diagram illustrating a configuration of a management system 10B according to the third embodiment of the present invention. The management system 10B of the third embodiment is different from the management system 10 (see FIG. 1) of the first embodiment in that an integrated server 400 is provided instead of the IC card management server 200 and the authentication server 300.

### Functional Configuration of Management System 10B—Third Embodiment

FIG. 14 is a functional block diagram of the management system 10B according to the third embodiment of the present invention. As illustrated in FIG. 14, the integrated server 400 according to the third embodiment includes an IC card managing unit 200B and an authenticating unit 300B. The IC card managing unit 200B has the same functions as the IC card management server 200 according to the first embodiment. The authenticating unit 300B has the same functions as the authentication server 300 according to the first embodiment.

That is, the integrated server 400 implements the functions of the IC card management server 200 and the functions of the authentication server 300 according to the first embodiment, by a single server. That is, since the functions and actions of the integrated server 400 are similar to those of the IC card management server 200 and the authentication server 300 according to the first embodiment, illustrations and descriptions thereof will be omitted.

Note that similarly in the management system 10A of the second embodiment, instead of the IC card management server 200 and the authentication server 300, the integrated server 400 may be provided.

### Fourth Embodiment

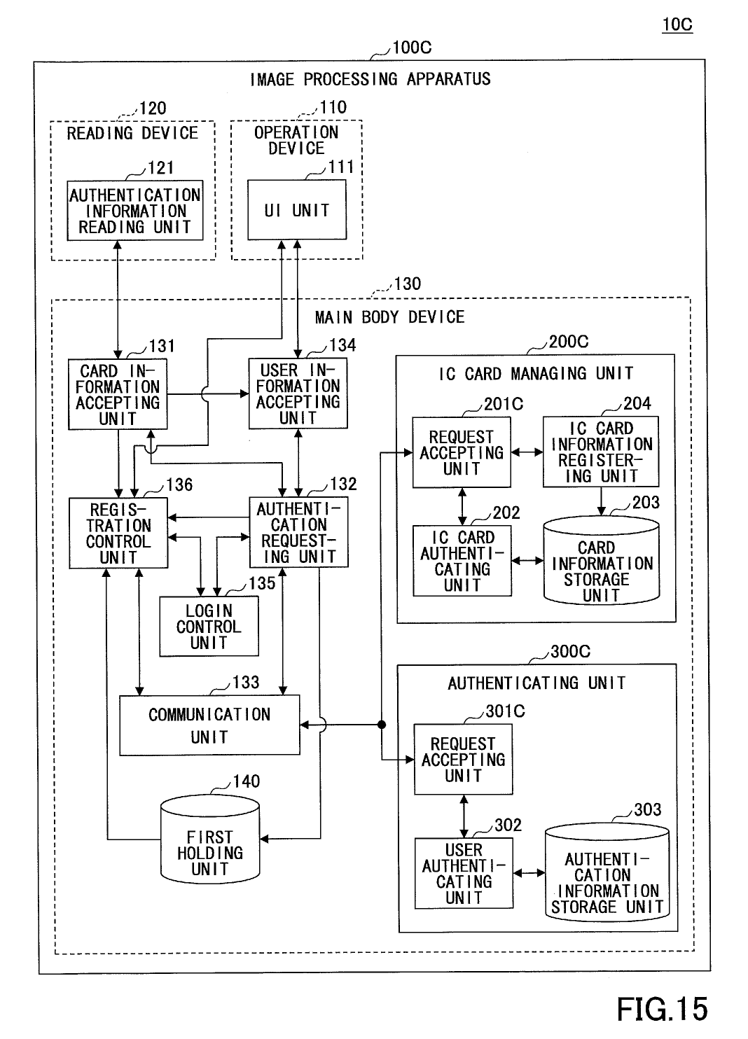

Next, a fourth embodiment of the present invention will be described with reference to FIG. 15. Only the differences from the third embodiment will be described below.

### Functional Configuration of Image Processing Apparatus 100C—Fourth Embodiment

FIG. 15 is a functional block diagram of an image processing apparatus 100C according to the fourth embodiment of the present invention. As illustrated in FIG. 15, the image processing apparatus 100C of the fourth embodiment forms a management system 100 by a single body. The image processing apparatus 100C includes an IC card managing unit 200C and an authenticating unit 300C in the main body device 130. That is, in the image processing apparatus 100C is provided with the same functions as those of the integrated server 400 according to the third embodiment. That is, since the functions and actions of the image processing apparatus 100C are the same as those of the image processing apparatus 100 and the integrated server 400 according to the third embodiment, illustrations and descriptions thereof will be omitted.

However, the image processing apparatus 100C is different from the third embodiment in that a requesting unit 133C is provided instead of the communication unit 133, in order to transmit and receive data within a single apparatus. Accordingly, the IC card managing unit 2000 is different from the IC card managing unit 200B according to the third embodiment in that the IC card managing unit 200C includes a request accepting unit 201C instead of the communication unit 201. Furthermore, the authenticating unit 300C is different from the authenticating unit 300B according to the third embodiment in that the authenticating unit 300C includes a request accepting unit 301C instead of the communication unit 301.

Note that similarly in the management system 10A according to the second embodiment, the functions of the integrated server 400 may be provided in the image processing apparatus 100A, instead of in the IC card management server 200 and the authentication server 300.

Although the preferred embodiments of the present invention have been described in detail above, the present invention is not limited to these embodiments, and various modifications or changes may be made within the scope of the present invention.

For example, in the above embodiments, an example in which the present invention is applied to an multifunction peripheral has been described; however, the present invention may also be applied to other image processing apparatuses (for example, a printer, a scanner, a projector, and an electronic blackboard, etc.).

In the above embodiments, IC card information is used as an example of the “first authentication information” according to an embodiment of the present invention; however, any other authentication information (for example, fingerprint information and finger vein information, etc.) may be used. That is, in the above-described embodiments, an IC card reader is used as an example of the “reading device” according to an embodiment of the present invention; however, any other reading device (for example, a fingerprint reading device and a finger vein reading device, etc.) may be used.

In the above embodiments, the user authentication is performed by the authentication server 300. However, information necessary for user authentication may be cached in the IC card management server 200 or the image processing apparatus 100, and the IC card management server 200 or the image processing apparatus 100 may perform user authentication.

In the above embodiments, the IC card authentication is performed by the IC card management server 200. However, information required for the IC card authentication may be cached in the authentication server 300 or the image processing apparatus 100, and the authentication server 300 or the image processing apparatus 100 may perform the IC card authentication.

In the above embodiments, data (a user authentication request and a user authentication result) is transmitted directly between the image processing apparatus 100 and the authentication server 300; however, the data may be transmitted between the image processing apparatus 100 and the authentication server 300 via the IC card management server 200.

Furthermore, an “operation” by a user means an action by the user, for example, an action of causing a card reader to read an IC card and an action of inputting information via an operation panel, etc.

The present invention can be implemented by a technical expert having common general knowledge of the technical field of information processing, by an apparatus configured by connecting ASIC (Application Specific Integrated Circuits) and conventional circuit modules. The respective functions described in the embodiments can be implemented by one or more processing circuits. Note that a “processing circuit” in the present specification includes a processor programmed to execute the respective functions by software, and hardware such as ASIC and circuit modules designed to execute the respective functions.

According to one embodiment of the present invention, it is possible for the user to easily use an image processing apparatus when the user registers authentication information that is input via a reading device.

The authentication method and the recording medium are not limited to the specific embodiments described in the detailed description, and variations and modifications may be made without departing from the spirit and scope of the present invention.

What is claimed is:

1. An authentication method executed by a computer, the authentication method comprising:
requesting for user authentication based on first authentication information input via a reading device according to an operation by a user;
displaying, on a display device, a first screen used for inputting second authentication information including user identification information for identifying the user, in response to the user authentication being unsuccessful based on the first authentication information;
requesting for user authentication based on the second authentication information input via the first screen;
allowing the user to log in, in response to the user authentication being successful based on the second authentication information;
displaying, on the display device, a second screen used for the user to input an instruction as to whether to register the first authentication information, in response to the user being allowed to log in; and
controlling the first authentication information and the user identification information included in the second authentication information to be registered in association with each other, in response to the first authentication information being instructed to be registered via the second screen.

2. The authentication method according to claim 1, further comprising:
holding the first authentication information, in response to the user authentication being unsuccessful based on the first authentication information, wherein
the displaying of the second screen includes determining whether the first authentication information is held, in response to the login of the user being allowed, and displaying the second screen on the display device, in response to determining that the first authentication information is held, and
the controlling includes controlling the held first authentication information and the user identification information included in the second authentication information to be registered in association with each other.

3. The authentication method according to claim 2, wherein
the requesting for the user authentication based on the second authentication information includes deleting the held first authentication information, in response to the user authentication being unsuccessful based on the second authentication information, and
the controlling includes deleting the held first authentication information, in response to the first authentication information and the user identification information included in the second authentication information being registered in association with each other.

4. The authentication method according to claim 1, further comprising:
holding association information associating the first authentication information and the user identification information included in the second authentication information, in response to the first authentication information being instructed not to be registered via the second screen; and
acquiring the user identification information corresponding to the first authentication information in the held association information, in response to the user authentication being unsuccessful based on the first authentication information, wherein
the displaying of the first screen includes displaying the first screen on the display device, based on the acquired user identification information.

5. The authentication method according to claim 4, wherein
the displaying of the first screen includes displaying, on the display device, the first screen in which the acquired user identification information is input, and
the requesting for the user authentication based on the second authentication information includes requesting for the user authentication based on the second authentication information including the acquired user identification information.

6. The authentication method according to claim 4, wherein the holding includes deleting the held association information including the first authentication information, in response to the first authentication information being instructed to be registered via the second screen.

7. A non-transitory computer-readable recording medium storing a program that causes a computer to execute a process, the process comprising:
requesting for user authentication based on first authentication information input via a reading device according to an operation by a user;
displaying, on a display device, a first screen used for inputting second authentication information including user identification information for identifying the user, in response to the user authentication being unsuccessful based on the first authentication information;
requesting for user authentication based on the second authentication information input via the first screen;
allowing the user to log in, in response to the user authentication being successful based on the second authentication information;
displaying, on the display device, a second screen used for the user to input an instruction as to whether to register the first authentication information, in response to the user being allowed to log in; and
controlling the first authentication information and the user identification information included in the second authentication information to be registered in association with each other, in response to the first authentication information being instructed to be registered via the second screen.

8. The non-transitory computer-readable recording medium according to claim 7, the process further comprising:
holding the first authentication information, in response to the user authentication being unsuccessful based on the first authentication information, wherein
the displaying of the second screen includes determining whether the first authentication information is held, in response to the login of the user being allowed, and displaying the second screen on the display device, in response to determining that the first authentication information is held, and
the controlling includes controlling the held first authentication information and the user identification information included in the second authentication information to be registered in association with each other.

9. The non-transitory computer-readable recording medium according to claim 8, wherein
the requesting for the user authentication based on the second authentication information includes deleting the held first authentication information, in response to the user authentication being unsuccessful based on the second authentication information, and
the controlling includes deleting the held first authentication information, in response to the first authentication information and the user identification information included in the second authentication information being registered in association with each other.

10. The non-transitory computer-readable recording medium according to claim 7, the process further comprising:
holding association information associating the first authentication information and the user identification information included in the second authentication information, in response to the first authentication information being instructed not to be registered via the second screen; and
acquiring the user identification information corresponding to the first authentication information in the held association information, in response to the user authentication being unsuccessful based on the first authentication information, wherein
the displaying of the first screen includes displaying the first screen on the display device, based on the acquired user identification information.

11. The non-transitory computer-readable recording medium according to claim 10, wherein
the displaying of the first screen includes displaying, on the display device, the first screen in which the acquired user identification information is input, and
the requesting for the user authentication based on the second authentication information includes requesting for the user authentication based on the second authentication information including the acquired user identification information.

12. The non-transitory computer-readable recording medium according to claim 10, wherein the holding includes deleting the held association information including the first authentication information, in response to the first authentication information being instructed to be registered via the second screen.
